(19) United States
(12) Patent Application Publication
(10) Pub. No.: US 2026/0369162 A1
(43) Pub. Date: Nov. 19, 2026

(54) ANALYSIS DEVICE, ANALYSIS METHOD, AND ANALYSIS PROGRAM

(71) Applicant: Sumitomo Electric Industries, Ltd., Osaka-shi, Osaka (JP)

(72) Inventor: Shintaro MATSUMOTO, Osaka-shi, Osaka (JP)

(73) Assignee: Sumitomo Electric Industries, Ltd., Osaka-shi, Osaka (JP)

(21) Appl. No.: 19/121,146

(22) PCT Filed: Jun. 5, 2023
(86) PCT No.: PCT/JP2023/020871

§ 371 Date: Apr. 15, 2025

(30) Foreign Application Priority Data
Oct. 19, 2022 (JP) 2022-167509

(51) Int. Cl. G08G 1/01; G08G 1/052; G08G 1/056

(52) U.S. Cl. CPC G08G 1/0133; G08G 1/0112; G08G 1/0145; G08G 1/052; G08G 1/056

(57) ABSTRACT

An analysis device includes: a detection unit configured to, on a road logically divided into a plurality of sections, detect a bottleneck point that is a starting point of traffic congestion, based on a traveling state of a vehicle on each of the plurality of sections; and a classification unit configured to classify the bottleneck point by at least one of a type and a degree of the bottleneck point, based on speeds of the vehicle in the sections on an upstream side and a downstream side of the bottleneck point detected by the detection unit.

### TECHNICAL FIELD

The present disclosure relates to an analysis device, an analysis method, and an analysis program. This application claims priority on Japanese Patent Application No. 2022-167509 filed on Oct. 19, 2022, the entire content of which is incorporated herein by reference.

### BACKGROUND ART

Patent Literature 1 and Patent Literature 2 each disclose a device for detecting an intersection, which is a bottleneck (hereinafter, also referred to as “bottleneck intersection”) when traffic congestion has occurred, by using probe information transmitted from traveling vehicles.

### CITATION LIST

### Patent Literature

PATENT LITERATURE 1: Japanese Laid-Open Patent Publication No. 2011-180667

PATENT LITERATURE 2: Japanese Laid-Open Patent Publication No. 2013-232160

### SUMMARY OF THE INVENTION

An analysis device according to an embodiment of the present disclosure includes: a detection unit configured to, on a road logically divided into a plurality of sections, detect a bottleneck point that is a starting point of traffic congestion, based on a traveling state of a vehicle on each of the plurality of sections; and a classification unit configured to classify the bottleneck point by at least one of a type and a degree of the bottleneck point, based on speeds of the vehicle in the sections on an upstream side and a downstream side of the bottleneck point detected by the detection unit.

### BRIEF DESCRIPTION OF DRAWINGS

FIG. 1 shows an example of an entire configuration of an analysis system according to an embodiment.

FIG. 2 is a block diagram showing an example of a hardware configuration of an in-vehicle network of a probe vehicle.

FIG. 3 is a block diagram showing an example of a hardware configuration of a traffic information analysis server.

FIG. 4 is a functional block diagram showing an example of the functions of the traffic information analysis server.

FIG. 5 illustrates an example of a bottleneck point.

FIG. 6 illustrates an example of determining a section corresponding to probe information.

FIG. 7 illustrates an example of bottleneck point detection.

FIG. 8 illustrates an example of bottleneck point classification according to a length in which the same speed range continues.

FIG. 9 illustrates an example of bottleneck point classification according to a speed recovery direction.

FIG. 10 shows an example of a map screen displayed on a terminal.

FIG. 11 shows an example of an enlarged map screen displayed on a terminal.

FIG. 12 is a flowchart showing an example of an analysis process by the traffic information analysis server according to the embodiment.

FIG. 13 is a flowchart showing an example of an analysis result provision process by the traffic information analysis server according to the embodiment.

### DETAILED DESCRIPTION

### Problems to be Solved by the Present Disclosure

In order to consider measures to improve traffic congestion, it is important to detect a bottleneck intersection. However, in order to more efficiently improve traffic congestion, it is not enough to simply specify which intersection is a bottleneck.

### Effects of the Present Disclosure

According to the present disclosure, it is possible to acquire information for considering efficient measures to improve traffic congestion.

### Description of Embodiment of the Present Disclosure

Hereinafter, the outline of an embodiment of the present disclosure is listed and described.

(1) An analysis device according to the present embodiment includes: a detection unit configured to, on a road logically divided into a plurality of sections, detect a bottleneck point that is a starting point of traffic congestion, based on a traveling state of a vehicle on each of the plurality of sections; and a classification unit configured to classify the bottleneck point by at least one of a type and a degree of the bottleneck point, based on speeds of the vehicle in the sections on an upstream side and a downstream side of the bottleneck point detected by the detection unit. Therefore, it is possible to acquire at least one of the type and the degree of the bottleneck point which are useful in considering efficient measures to improve traffic congestion.

(2) In the above (1), the detection unit may detect the bottleneck point, based on a change in speed of the vehicle in adjacent sections. Thus, for example, if the change in speed of the vehicle in the adjacent sections is great, a bottleneck point existing in these sections can be detected.

(3) In the above (1), the detection unit may detect a downstream end of a first section as a bottleneck point, based on a difference between a first speed and a second speed, the first speed being the speed of a first vehicle in the first section, the second speed being the speed of a second vehicle in a second section adjacent to the first section at a downstream side of the first section. Thus, for example, if the difference between the first speed and the second speed is great, a bottleneck point existing in the first section can be detected.

(4) In the above (3), the detection unit may detect the downstream end of the first section as a bottleneck point when the difference between the second speed and the first speed is equal to or higher than a threshold value. Thus, a bottleneck point existing at the downstream end of the first section can be detected.

(5) In the above (1), the analysis device may further include an allocation unit configured to allocate, to each section, one of a plurality of predetermined speed ranges, based on the speeds of the vehicle in the plurality of sections. The detection unit may detect the bottleneck point, based on a change in speed range in adjacent sections. Thus, for example, if the change in speed range in the adjacent sections is great, a bottleneck point existing in these sections can be detected.

(6) In any one of the above (1) to (5), the type may include at least one of: whether or not the bottleneck point is an intersection where a traffic light is installed; and a heading direction, of the vehicle, in which the speed of the vehicle recovers at the bottleneck point. For example, when the bottleneck point is an intersection with a traffic light, there is a possibility that traffic congestion is improved by changing the traffic light control pattern. In another example, there is a possibility that traffic congestion is improved by changing the traffic light control pattern so as to increase the amount of vehicle traffic in the direction in which the vehicle speed recovers. Therefore, information useful for considering measures to improve traffic congestion can be included in the type of the bottleneck point.

(7) In any one of the above (1) to (6), the degree may include at least one of: a change in speed range of the vehicle between a first section having the bottleneck point at a downstream end thereof and a second section adjacent to the first section at a downstream side of the first section; a length in which the same speed range continues on the downstream side from the bottleneck point; and a length in which the same speed range continues on the upstream side from the bottleneck point. For example, between a bottleneck point where the speed range changes from the low speed to the high speed and a bottleneck point where the speed range changes from the intermediate speed to the high speed, it is considered that improving the former will have a greater improvement effect than improving the latter. The length in which the same speed range continues on the downstream side from the bottleneck point is the length (distance) over which the vehicle, after having passed through the bottleneck point, can continue traveling at the recovered speed. Between a bottleneck point where the travelable distance at the recovered speed is long and a bottleneck point where the travelable distance at the recovered speed is short, it is considered that improving the former will have a greater improvement effect than improving the latter. Furthermore, the length in which the same speed range continues on the upstream side from the bottleneck point is the length of a queue of vehicles traveling at low speeds or repeating stop and start (hereinafter also referred to as “low-speed vehicle queue”) at the bottleneck point. Between a bottleneck point where the low-speed vehicle queue is long and a bottleneck point where the low-speed vehicle queue is short, it is considered that improving the former will have a greater improvement effect than improving the latter. Therefore, information useful for considering measures to improve traffic congestion can be included in the degree of the bottleneck point.

(8) In any one of the above (1) to (7), the analysis device may further include a generation unit configured to generate display data for superimposing and displaying the detected bottleneck point on a map. This allows the user to visually grasp the bottleneck point.

(9) In the above (8), the display data may be data for displaying, in a specific first mode, an area where the same speed range continues on the upstream side of the bottleneck point on a road included in the map. This enables the user to visually grasp traffic congestion that has occurred starting from the bottleneck point.

(10) In the above (8) or (9), the display data may be data for displaying, in a specific second mode, an area where the same speed range continues on the downstream side of the bottleneck point on a road included in the map. This enables the user to visually grasp the travelable area at the recovered speed after passing through the bottleneck point.

(11) An analysis method according to the present embodiment includes: on a road logically divided into a plurality of sections, detecting a bottleneck point that is a starting point of traffic congestion, based on a traveling state of a vehicle on each of the plurality of sections; and classifying the bottleneck point by at least one of a type and a degree of the bottleneck point, based on speeds of the vehicle in the sections on an upstream side and a downstream side of the detected bottleneck point. Therefore, it is possible to acquire at least one of the type and the degree of the bottleneck point which are useful in considering efficient measures to improve traffic congestion.

(12) An analysis program according to the present embodiment causes a computer to execute: on a road logically divided into a plurality of sections, detecting a bottleneck point that is a starting point of traffic congestion, based on a traveling state of a vehicle on each of the plurality of sections; and classifying the bottleneck point by at least one of a type and a degree of the bottleneck point, based on speeds of the vehicle in the sections on an upstream side and a downstream side of the detected bottleneck point. Therefore, it is possible to acquire at least one of the type and the degree of the bottleneck point which are useful in considering efficient measures to improve traffic congestion.

The present disclosure can be realized as an analysis device including such a characteristic configuration as above, an analysis method having steps of characteristic processes in the analysis device, or a computer program causing a computer to function as the analysis device. The present disclosure can also be realized as a system including the analysis device, or a part or the entirety of the analysis device can be realized as a semiconductor integrated circuit.

### Details of Embodiment of the Present Disclosure>

Hereinafter, the embodiment of the present disclosure will be described in detail with reference to the drawings. At least parts of the embodiment described below may be combined together as desired.

### [1. Definition of Terms]

In advance of describing the present embodiment in detail, terms used in this specification are defined as follows.

“Vehicle”: General vehicles that travel on roads. Therefore, in addition to automobiles, light automobiles, and trolleybuses, motorcycles also fall under the category of vehicles. Vehicle driving systems are not limited to internal combustion engines, and electric vehicles and hybrid vehicles are also included in the category of vehicles.

In this embodiment, the term “vehicle” simply refers to both a probe vehicle including an in-vehicle control device capable of transmitting probe information, and an ordinary vehicle that does not provide probe information to the outside.

“Probe information”: Various kinds of information, related to a probe vehicle, sensed by the probe vehicle traveling on a road. The probe information is also referred to as probe data or floating car data.

The probe information may include vehicle data such as identification information, a vehicle position, a vehicle speed, and a vehicle heading of the probe vehicle, and generation times thereof. Information such as a position and an acceleration acquired by a smartphone, a tablet, etc., in the vehicle may be used as the probe information.

“Probe vehicle”: A vehicle that senses probe information and transmits the probe information to the outside. Vehicles that travel on roads include probe vehicles and vehicles other than the probe vehicles.

However, even an ordinary vehicle having no in-vehicle control device capable of transmitting probe information is also regarded as a probe vehicle if the vehicle has a smartphone, a tablet PC, etc., capable of transmitting, to the outside, probe information including positional information and speed of the vehicle.

“Signal control parameter”: A cycle length, a split, and an offset that are temporal elements regarding traffic signal indication are collectively referred to as signal control parameters or signal control constants.

“Cycle length”: A time period of one cycle from green (or red) start time to next green (or red) start time of a traffic light. In Japan, it is determined by law that signal light that is actually green is referred to as “blue”.

“Split”: A ratio of time length assigned to each phase to the cycle length. Generally, a split is expressed by a percentage or a ratio. Strictly, a split is a value obtained by dividing an effective green interval by the cycle length.

“Offset”: In coordinated control or wide-area control, an offset is a deviation of a certain time point of signal indication, e.g., a starting time point of major-road green light, from a reference time point common to a group of traffic lights, or a deviation in the same signal indication starting time point between adjacent intersections. The former is referred to as an absolute offset and the latter is referred to as a relative offset, and each offset is represented by a percentage of time (seconds) or cycle.

“Green interval”: A time period during which vehicles have right of way at an intersection. A green interval ending time point may be set to a green light extinction time point at the earliest, or to a yellow light extinction time point at the latest. In the case of an intersection having an arrow light, a green interval ending time point may be a right-turn arrow ending time point.

“Red interval”: A time period during which vehicles do not have right of way at an intersection. A red interval starting time point may be set to a green light extinction time point at the earliest, or to a yellow light extinction time point at the latest. In the case of an intersection having an arrow light, a red interval starting time point may be a right-turn arrow ending time point.

As described above, in the present embodiment, time periods included in one cycle are roughly classified into a green interval in which vehicles have right of way and a red interval in which vehicles do not have right of way. Therefore, assuming that the green interval is G, the red interval is R, and the cycle length is C, a relationship of C=G+R is satisfied.

“Link”: A road section having an upbound or downbound direction and connecting nodes such as intersections (a section obtained by logically dividing a road). A link is also referred to as “road link”. When viewed from a certain intersection, a link in a direction that flows in toward this intersection is referred to as an inflow link. When viewed from a certain intersection, a link in a direction that flows out from this intersection is referred to as an outflow link.

### [2. Analysis System]

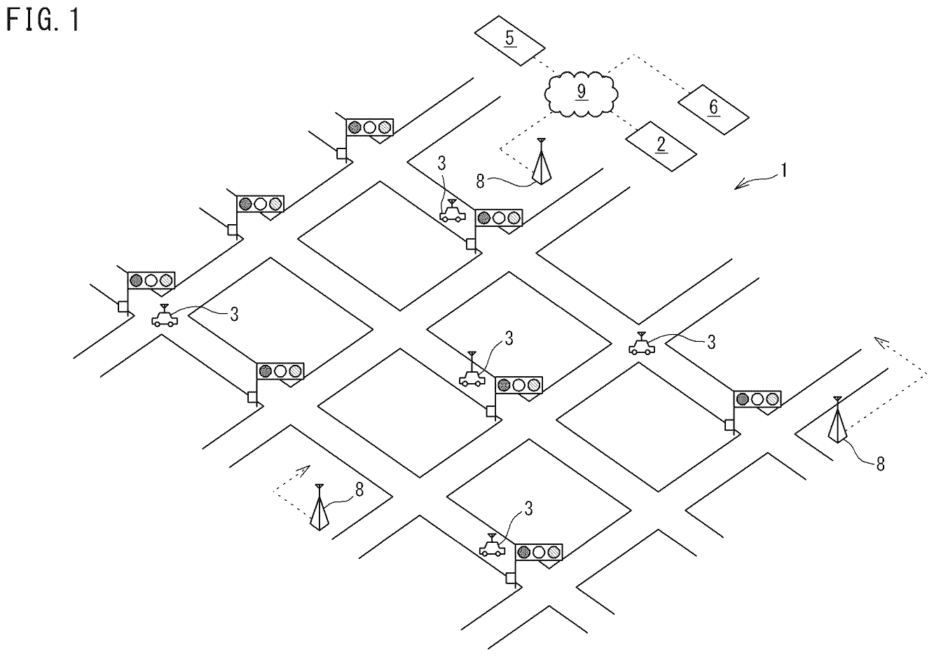

FIG. 1 shows an example of an entire configuration of an analysis system according to an embodiment. An analysis system 1 according to the present embodiment is a system for analyzing traffic information, based on probe information transmitted from a vehicle. The analysis system 1 includes a traffic information analysis server 2, probe vehicles 3, a collection server 5, and a terminal 6.

Each probe vehicle 3 is equipped with an in-vehicle control device, and transmits probe information acquired by the in-vehicle control device. The probe information includes at least position information and vehicle speed information.

The probe vehicle 3 is capable of wirelessly communicating with wireless base stations 8 (e.g., mobile base stations) in various locations. Each wireless base station 8 is communicable with the collection server 5 via a public communication network 9 including a mobile communication core network, the Internet, etc.

The probe vehicle 3 wirelessly transmits a communication packet that includes uplink data and is addressed to the collection server 5, to the wireless base station 8. The uplink data includes the probe information sensed by the probe vehicle 3, and the like.

The collection server 5 collects the probe information transmitted from the probe vehicle 3. The collection server 5 includes a database (not shown), and stores the collected probe information into the database.

The traffic information analysis server 2 analyzes traffic information by using the probe information collected by the collection server 5. Specifically, the traffic information analysis server 2, based on the probe information, detects a traffic bottleneck point, and classifies the bottleneck point by its type and degree. The traffic information analysis server 2 is an example of “analysis device”.

An operating entity of the traffic information analysis server 2 is not particularly limited. For example, the operating entity of the traffic information analysis server 2 may be a manufacturer of probe vehicles 3, an IT company carrying out various types of information services, or a public enterprise in charge of traffic control. The traffic information analysis server 2 may be operated as either an on-premises server or a cloud server.

The traffic information analysis server 2 provides the terminal 6 with an analysis result in response to a request from the terminal 6. The terminal 6 includes a display device, and displays the analysis result of the traffic information analysis server 2. The terminal 6 is operated, for example, by a public enterprise in charge of traffic control. Utilizing the analysis result, the enterprise executes traffic control to improve congestion, such as determining signal control parameters.

### [3. Probe Vehicle]

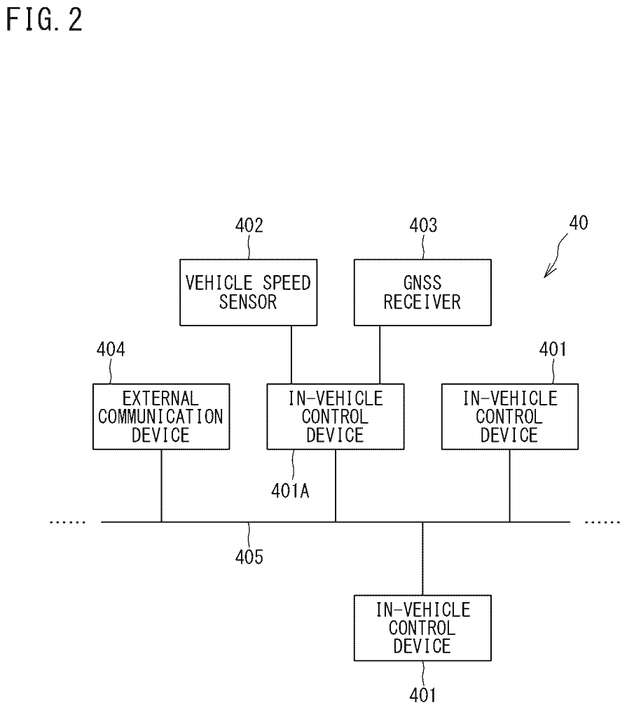

Each probe vehicle 3 is equipped with an in-vehicle network. FIG. 2 is a block diagram showing an example of a hardware configuration of an in-vehicle network of a probe vehicle.

An in-vehicle network 40 is a network in which a plurality of in-vehicle control devices 401 are communicably connected to each other. The in-vehicle control devices 401 include, for example, an in-vehicle control device that controls an engine, an in-vehicle control device that controls a transmission, an in-vehicle control device that controls a brake, an in-vehicle control device that controls doors, an in-vehicle control device that controls an air conditioner, and the like.

The in-vehicle control devices 401 are connected to each other by a communication line 405 that is a bus, for example. The in-vehicle control devices 401 each include a communication interface using a specific communication protocol, e.g., CAN (Controller Area Network) or Ethernet (registered trademark), and are capable of communicating with each other. The topology of the in-vehicle network 40 is not limited to a bus type, and may be a star type or a ring type.

The in-vehicle control device 401A generates probe information, and transmits the generated probe information. The in-vehicle control device 401A is connected to a vehicle speed sensor 402 and a GNSS (Global Navigation Satellite System) receiver 403. The vehicle speed sensor 402 measures the vehicle speed of the probe vehicle 3, and outputs data of the measured vehicle speed. The GNSS receiver 403 receives signals transmitted from a plurality of positioning satellites, and measures the position of the GNSS receiver 403 (i.e., the probe vehicle 3) based on the transmission time and the reception time of each signal. The in-vehicle control device 401A generates probe information including vehicle speed information outputted from the vehicle speed sensor 402 and position information outputted from the GNSS receiver 403, and transmits the generated probe information.

The in-vehicle control device 401A may include, for example, a timer (not shown). The in-vehicle control device 401A can include, in the probe information, time information (time stamp) obtained by the timer.

An external communication device 404 is connected to the communication line 405. The external communication device 404 can wirelessly communicate with devices outside the vehicle. For example, the external communication device 404 includes a communication interface for mobile communication systems such as 5G (fifth generation mobile communication system) and 4G (fourth generation mobile communication system), and can communicate with external devices (e.g., the collection server 5) through the wireless base station 8.

The probe information outputted from the in-vehicle control device 401A is protocol converted by the external communication device 404, and is transmitted from the external communication device 404 as a communication packet addressed to the collection server 5. The collection server 5 receives pieces of probe information transmitted from a plurality of vehicles, and stores the received probe information in the database.

### [4. Traffic Information Analysis Server]

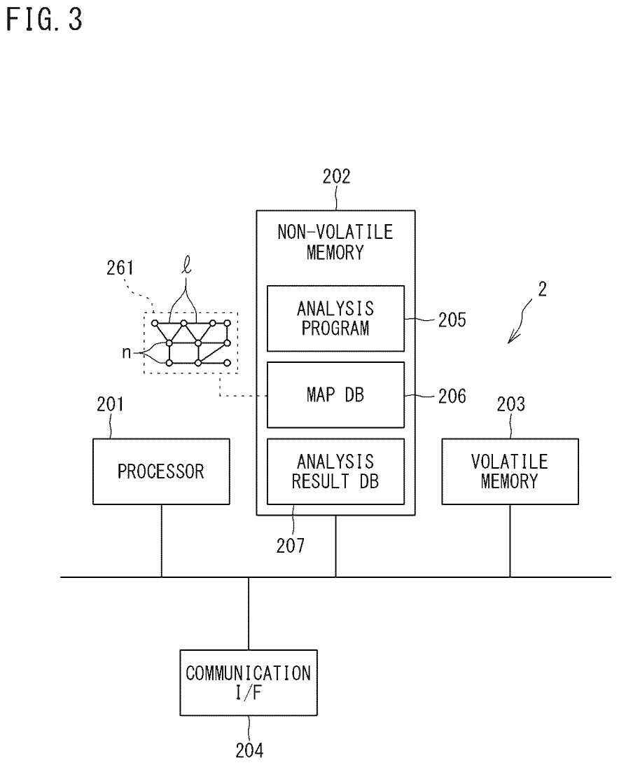

FIG. 3 is a block diagram showing an example of a hardware configuration of a traffic information analysis server. The traffic information analysis server 2 includes a processor 201, a non-volatile memory 202, a volatile memory 203, and a communication interface (I/F) 204.

The volatile memory 203 is a semiconductor memory such as an SRAM (Static Random Access Memory) or a DRAM (Dynamic Random Access Memory), for example. The non-volatile memory 202 is, for example, a flash memory, a hard disk, a ROM (Read Only Memory), or the like. The non-volatile memory 202 stores therein an analysis program 205, which is a computer program, and data to be used for execution of the analysis program 205. Each function of the traffic information analysis server 2 is achieved by the analysis program 205 being executed by the processor 201. The analysis program 205 can be stored in a recording medium such as a flash memory, a ROM, or a CD-ROM. The processor 201, based on the analysis program 205, detects a bottleneck point and classifies the detected bottleneck point.

The non-volatile memory 202 is provided with a map database (hereinafter also referred to as “map DB”) 206. Road map data 261 is recorded in the map DB 206. The road map data 261 includes intersection data and link data.

The “intersection data” is data in which an intersection ID assigned to a domestic intersection is associated with position information of the intersection.

The “link data” is data in which the following information A to information D are associated with a link ID of a specific link assigned to a domestic road.
Information A: Position information of start/end/interpolation points of a specific link
Information B: Orientation information of the start/end/interpolation points of the specific link
Information C: Link ID that connects to the start point of the specific link
Information D: Link ID that connects to the end point of the specific link

The road map data 261 constitutes a network corresponding to actual road alignment and traveling directions on roads. Therefore, the road map data 261 is a network in which road sections between nodes representing intersections are connected by directed links 1 (lowercase letter l).

Specifically, the road map data 261 has a data structure including a directed graph in which a node n is set for each intersection, and a pair of adjacent nodes n are connected by a pair of directed links 1 in opposite directions. Therefore, in the case of a one-way road, nodes n are connected only by directed links 1 in one direction.

The road map data 261 further includes section information that is information on each section. One or a plurality of sections are assigned to each link. The section information specifies the positions of a start point and an end point of each section into which the link is divided.

The non-volatile memory 202 is provided with an analysis result database (hereinafter also referred to as “analysis result DB”) 207. In the analysis result DB 207, an analysis result according to the analysis program 205 is stored. Specifically, in the analysis result DB 207, position information of a bottleneck point and the type and degree of the bottleneck point are stored.

The processor 201 is, for example, a CPU (Central Processing Unit). However, the processor 201 is not limited to a CPU. The processor 201 may be a GPU (Graphics Processing Unit). The processor 201 is, for example, a multicore processor. The processor 201 may be a single core processor. The processor 201 may be, for example, an ASIC (Application Specific Integrated Circuit) or a programmable logic device such as a gate array or an FPGA (Field Programmable Gate Array). In this case, the ASIC or the programmable logic device is configured to be able to execute the same processing as the analysis program 205.

The communication I/F 204 is connected to the public communication network 9. The communication I/F 204 is, for example, an Ethernet interface, and can communicate with other devices (the external communication device 404, the collection server 5, etc.) through the public communication network 9 by using a communication protocol such as TCP/IP (Transmission Control Protocol/Internet Protocol).

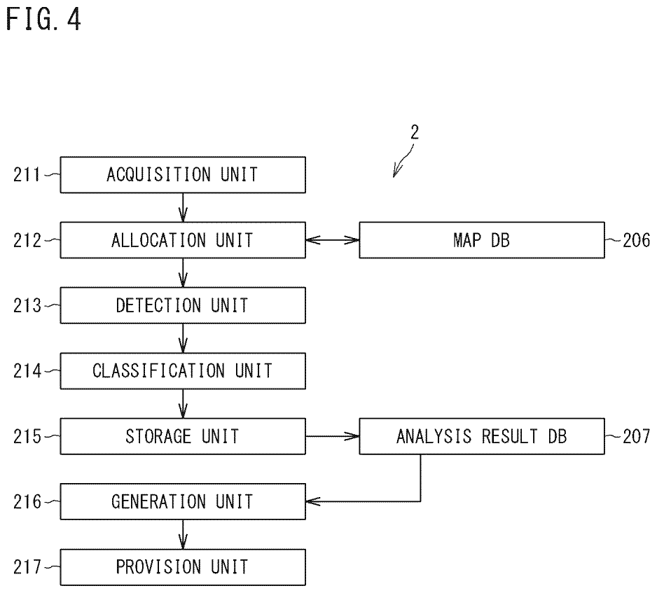

Next, the functions of the traffic information analysis server 2 will be described. FIG. 4 is a functional block diagram showing an example of the functions of the traffic information analysis server.

The traffic information analysis server 2 has the functions of an acquisition unit 211, an allocation unit 212, a detection unit 213, a classification unit 214, a storage unit 215, a generation unit 216, and a provision unit 217. The processor 201 executes the analysis program 205, whereby the functions of the detection unit 213, the classification unit 214, the storage unit 215, the generation unit 216, and the provision unit 217 are realized.

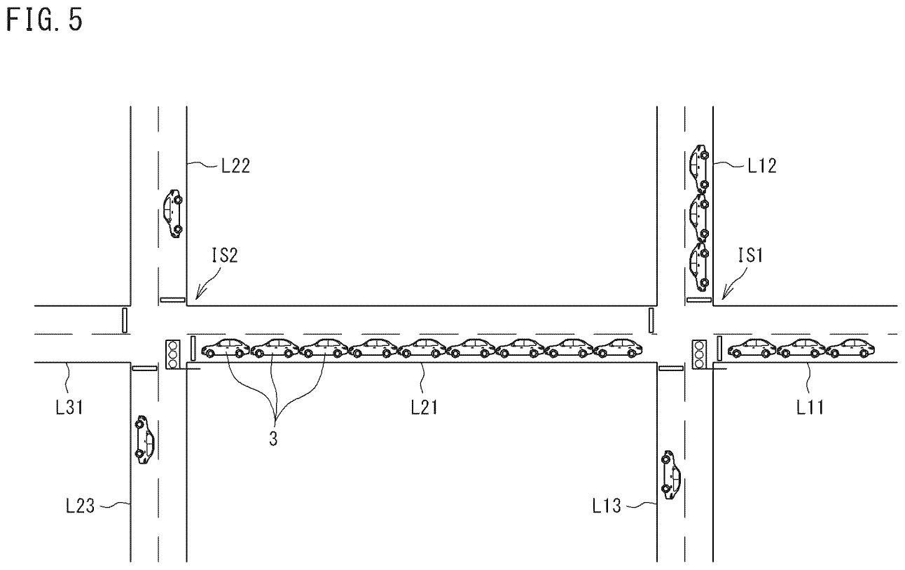

The traffic information analysis server 2 detects a traffic bottleneck point on a road, and classifies the detected bottleneck point. FIG. 5 illustrates an example of a bottleneck point. Links L11, L21, and L31 are linearly connected. The link L11 is connected to the link L21 at an intersection IS1, and the link L21 is connected to the link L31 at an intersection IS2. The road shown in FIG. 5 is a bidirectional two-lane road, and the links L11, L21, L31 correspond to one lane in the direction from right to left in FIG. 5. That is, the link L11 is an inflow lane of the intersection IS1. The link L21 is an outflow lane of the intersection IS1 and an inflow lane of the intersection IS2. The link L31 is an outflow lane of the intersection IS2.

The intersection IS1 is a crossroads, and links L12, L13 also extend from the intersection IS1 in addition to the links L11, L21. The links L12 and L13 are inflow lanes of the intersection IS1. The intersection IS2 is a crossroads, and links L22, L23 also extend from the intersection IS2 in addition to the links L21, L31. The links L22 and L23 are inflow lanes of the intersection IS2.

In the links L11 and L21, traffic congestion has occurred, and a queue of vehicles that are traveling at low speeds or repeating stop and start (also referred to as “low-speed vehicle queue”) continues. Also, in the link L12, a low-speed vehicle queue continues. At the intersection IS1, the traffic congestion has not been solved. In other words, the vehicle speed that is low in the link L11 does not recover in the link L21 after the vehicle has passed through the intersection IS1, and maintains the low speed. Also, the vehicle speed that is low in the link L12 does not recover after the vehicle has passed through the intersection IS1 and flows into the link L21 in the right-turn direction, and maintains the low speed.

On the other hand, the vehicle speed that is low in the link L21 recovers in the link L31 after the vehicle has passed through the intersection IS2, and changes to a high speed. That is, the traffic congestion has occurred starting from the intersection IS2. Thus, the intersection IS2 is a traffic bottleneck point. In contrast, the intersection IS1, where the vehicle speed does not recover even after the vehicle has passed through it, is not a bottleneck point.

The traffic information analysis server 2 detects a bottleneck point as described above, and classifies the detected bottleneck point by its type and degree.

Referring back to FIG. 4, the acquisition unit 211 acquires the probe information from the collection server 5. For example, the traffic information analysis server 2 analyzes traffic information for a set analysis target period. In this case, the acquisition unit 211 acquires probe information including time information within the analysis target period.

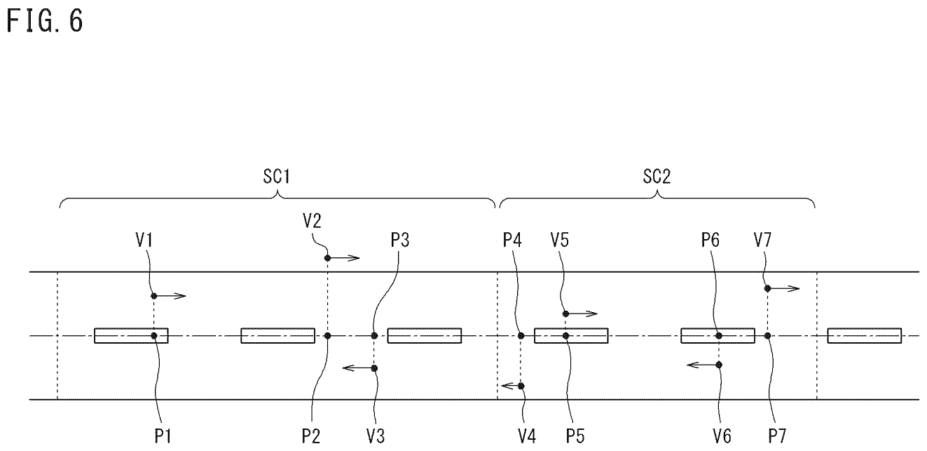

The allocation unit 212 determines a section corresponding to the probe information. FIG. 6 illustrates an example of determining a section corresponding to the probe information. For example, a link is set along the center line of a road. The vehicle position information included in the probe information does not necessarily indicate a point on the link, and indicates a point that deviates from the link, in many cases. For example, the allocation unit 212 specifies a point, on the link, that has the shortest distance (Euclidean distance) from the vehicle position, and determines a section including the specified point, as the section corresponding to the probe information (i.e., the vehicle).

In determining the section corresponding to the probe information, the allocation unit 212 refers to the road map data 261 in the map DB 206. That is, the allocation unit 212 specifies a start point and an end point of each section by using the section information included in the road map data 261, and determines which section the vehicle position specified by the probe information corresponds to.

In the example shown in FIG. 6, a point (hereinafter also referred to as “closest point”), on the link, that has the shortest distance from the position in the probe information (hereinafter also referred to as “probe position”) of a vehicle V1 is a point P1. Since the point P1 is included in a section SC1, the vehicle V1 corresponds to the section SC1. The closest point, on the link, to the probe position of a vehicle V2 is a point P2. Since the point P2 is included in the section SC1, the vehicle V2 corresponds to the section SC1. The closest point, on the link, to the probe position of a vehicle V3 is a point P3. Since the point P3 is included in the section SC1, the vehicle V3 corresponds to the section SC1. The closest point, on the link, to the probe position of a vehicle V4 is a point P4. Since the point P4 is included in a section SC2, the vehicle V4 corresponds to the section SC2. The closest point, on the link, to the probe position of a vehicle V5 is a point P5. Since the point P5 is included in the section SC2, the vehicle V5 corresponds to the section SC2. The closest point, on the link, to the probe position of a vehicle V6 is a point P6. Since the point P6 is included in the section SC2, the vehicle V6 corresponds to the section SC2. The closest point, on the link, to the probe position of a vehicle V7 is a point P7. Since the point P7 is included in the section SC2, the vehicle V7 corresponds to the section SC2.

For example, the probe information includes information on the traveling direction of the vehicle. Alternatively, the allocation unit 212 tracks a change in the vehicle position indicated by the probe information, and detects the traveling direction of the vehicle. The allocation unit 212 discriminates the probe information for each road traveling direction. This will be described with reference to FIG. 6. In FIG. 6, a lane in the direction heading from left to right is referred to as “upbound lane”, and a lane in the direction heading from right to left is referred to as “downbound lane”. In FIG. 6, arrows indicate vehicle traveling directions. The vehicles V1, V2, V5, V7 are traveling in an upbound direction, and the vehicles V3, V4, V6 are traveling in a downbound direction.

The allocation unit 212 allocates, to each section, one of a plurality of predetermined speed ranges, based on the vehicle speeds in the plurality of sections. This will be described with reference to FIG. 6. The allocation of speed ranges to sections is performed for each lane direction. That is, a speed range is allocated to each of the upbound direction and the downbound direction of a certain section.

In FIG. 6, the vehicles V1, V2 correspond to the upbound direction in the section SC1. In one example, the allocation unit 212 determines a representative value of the vehicle speeds of the vehicles V1, V2. The vehicle V3 corresponds to the downbound direction in the section SC1. In this case, the vehicle speed of the vehicle V3 becomes a representative value. The vehicles V5, V7 correspond to the upbound direction in the section SC2. The allocation unit 212 determines a representative value of the vehicle speeds of the vehicles V5, V7. The vehicles V4, V6 correspond to the downbound direction in the section SC2. The allocation unit 212 determines a representative value of the vehicle speeds of the vehicles V4, V6.

The representative value may be an average value, a median value, or another value. As another example, the allocation unit 212 may select one of a plurality of vehicle speeds and use the selected vehicle speed instead of the representative value.

A plurality of speed ranges are set in advance in the traffic information analysis server 2. For example, a speed range not lower than 0 km/h and not higher than 5 km/h is “low speed”, a speed range higher than 5 km/h and not higher than 15 km/h is “intermediate speed” and a speed range higher than 15 km/h is “high speed”.

The allocation unit 212 allocates, to a section, the speed range to which the representative value of the vehicle speed in this section belongs. For example, it is assumed that the representative value of the vehicle speed in the upbound direction in the section SC1 is 25 km/h. In this case, “high speed” is allocated to the upbound direction in the section SC1. It is assumed that the representative value of the vehicle speed in the downbound direction in the section SC1 is 20 km/h. In this case, “high speed” is allocated to the downbound direction in the section SC1. It is assumed that the representative value of the vehicle speed in the upbound direction in the section SC2 is 10 km/h. In this case, “intermediate speed” is allocated to the upbound direction in the section SC2. It is assumed that the representative value of the vehicle speed in the downbound direction in the section SC2 is 3 km/h. In this case, “low speed” is allocated to the downbound direction in the section SC2.

Referring back to FIG. 4, the detection unit 213 detects a bottleneck point that is a starting point of traffic congestion, based on the traveling states of vehicles in the respective sections. In one example, the detection unit 213 detects a bottleneck point, based on a change in vehicle speed between adjacent sections.

In the present embodiment, the detection unit 213 detects a bottleneck point, based on a change in speed range between adjacent sections. Specifically, between the adjacent sections, if the speed range in the section on the downstream side in the traveling direction is higher than the speed range in the section on the upstream side in the traveling direction, the detection unit 213 detects a downstream end of the upstream-side section, as a bottleneck point. Here, the “upstream” means a side in the opposite direction to the vehicle traveling direction as seen from a position on the road, and the “downstream” means a side toward the vehicle traveling direction as seen from the position on the road.

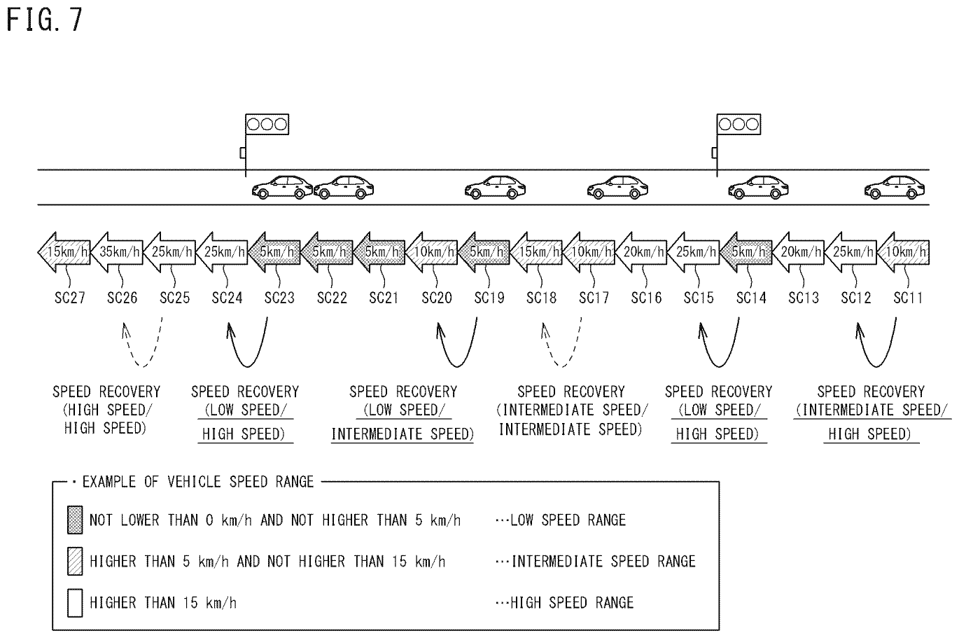

A more specific description will be given with reference to the drawings. FIG. 7 illustrates an example of bottleneck point detection. In FIG. 7, arrows represent sections, and the text in each arrow indicates the vehicle speed (representative value) in the corresponding section. The direction of the arrows indicates the direction of the lane. Patterns on the arrows indicate the speed ranges. A diagonal grid pattern indicates “low speed”, a diagonal line pattern indicates “intermediate speed”, and no pattern (white) indicates “high speed”.

In FIG. 7, the section SC11 and the section SC12 are adjacent to each other, the speed range of the upstream-side section SC11 is “intermediate speed”, and the speed range of the downstream-side section SC12 is “high speed”. That is, the speed range (high speed) of the downstream-side section SC12 is higher than the speed range (intermediate speed) of the upstream-side section SC11. Therefore, the detection unit 213 detects the downstream end of the upstream-side section SC11 as a bottleneck point. The section SC14 and the section SC15 are adjacent to each other, the speed range of the upstream-side section SC14 is “low speed”, and the speed range of the downstream-side section SC15 is “high speed”. That is, the speed range (high speed) of the downstream-side section SC15 is higher than the speed range (low speed) of the upstream-side section SC14. Therefore, the detection unit 213 detects the downstream end of the upstream-side section SC14 as a bottleneck point. Likewise, since the speed range changes from the low speed to the intermediate speed in the adjacent sections SC19 and SC20, the downstream end of the section SC19 is a bottleneck point. Since the speed range changes from the low speed to the high speed in the adjacent sections SC23 and SC24, the downstream end of the section SC23 is a bottleneck point.

Another example of bottleneck point detection will be described. The detection unit 213 can detect a downstream end of a first section as a bottleneck point, based on a difference between a first speed of the vehicle in the first section and a second speed of the vehicle in a second section adjacent to the first section at the downstream side of the first section. In a more specific example, when the difference between the second speed and the first speed is equal to or higher than a threshold value, the detection unit 213 can detect the downstream end of the first section as a bottleneck point.

In the example shown in FIG. 7, the vehicle speed (first vehicle speed) of the section SC11 (first section) is 10 km/h, and the vehicle speed (second vehicle speed) of the section SC12 (second section) is 25 km/h. For example, assuming that the threshold value is 5 km/h, a difference of 15 km/h between the second vehicle speed and the first vehicle speed is not lower than the threshold value, so that the downstream end of the section SC11 is a bottleneck point. The vehicle speed (first vehicle speed) of the section SC14 (first section) is 5 km/h, and the vehicle speed (second vehicle speed) of the section SC15 (second section) is 25 km/h. A difference of 20 km/h between the second vehicle speed and the first vehicle speed is not lower than the threshold value, so that the downstream end of the section SC14 is a bottleneck point. Likewise, in the adjacent sections SC17 and SC18, the vehicle speed changes from 10 km/h to 15 km/h, and a difference of 5 km/h is not lower than the threshold value, so that the downstream end of the section SC17 is a bottleneck point. In the adjacent sections SC19 and SC20, the vehicle speed changes from 5 km/h to 10 km/h, and a difference of 5 km/h is not lower than the threshold value, so that the downstream end of the section SC19 is a bottleneck point. In the adjacent sections SC23 and SC24, the vehicle speed changes from 5 km/h to 25 km/h, and a difference of 20 km/h is not lower than the threshold value, so that the downstream end of the section SC23 is a bottleneck point. In the adjacent sections SC25 and SC26, the vehicle speed changes from 25 km/h to 35 km/h, and a difference of 10 km/h is not lower than the threshold value, so that the downstream end of the section SC25 is a bottleneck point.

The above-described detection of bottleneck points is an example, and the present disclosure is not limited thereto. The detection unit 213 may detect a bottleneck point by another detection method. For example, the detection unit 213 may detect a bottleneck point by the method disclosed in Patent Literature 1 or Patent Literature 2.

Referring back to FIG. 4, the classification unit 214 classifies the bottleneck point by at least one of the type and the degree of the bottleneck point, based on the vehicle speeds in the sections on the upstream side and the downstream side with respect to the bottleneck point detected by the detection unit 213.

In one example, the type includes whether or not the bottleneck point is an intersection with traffic light. That is, the classification unit 214 classifies bottleneck points into intersections with traffic light and other intersections. For example, in FIG. 7, the downstream end of the section SC14 is a bottleneck point, and this bottleneck point is an intersection with traffic light. The downstream end of the section SC23 is a bottleneck point, and this bottleneck point is an intersection with traffic light. The downstream end of the section SC11, the downstream end of the section SC17, the downstream end of the section SC19, and the downstream end of the section SC25 are not intersections with traffic light.

In one example, the degree includes a change in vehicle speed range between the first section including the bottleneck point, and the second section adjacent to the first section at the downstream side of the first section. That is, the classification unit 214 classifies the bottleneck point according to the change pattern of the vehicle speed range between the upstream-side first section and the downstream-side second section.

In the following description, the change pattern of the speed range from the first section to the second section is expressed as “(speed range of first section)/(speed range of second section)”. A description will be given with reference to FIG. 7. As for the bottleneck point at the downstream end of the section SC11, the speed range changes from the intermediate speed in the section SC11 to the high speed in the section SC12. Therefore, this bottleneck point is classified to a speed change pattern of “intermediate speed/high speed”. As for the bottleneck point at the downstream end of the section SC14, the speed range changes from the low speed in the section SC14 to the high speed in the section SC15. Therefore, this bottleneck point is classified to a speed change pattern of “low speed/high speed”. Likewise, the bottleneck point at the downstream end of the section SC17 is classified to a speed change pattern of “intermediate speed/intermediate speed”. The bottleneck point at the downstream end of the section SC19 is classified to a speed change pattern of “low speed/intermediate speed”. The bottleneck point at the downstream end of the section SC23 is classified to the speed change pattern of “low speed/high speed”. The bottleneck point at the downstream end of the section SC25 is classified to a speed change pattern of “high speed/high speed”.

The degree may include a length in which the same speed range continues on the downstream side from the bottleneck point. That is, the classification unit 214 classifies the bottleneck point by the length in which the same speed range continues on the downstream side from the bottleneck point.

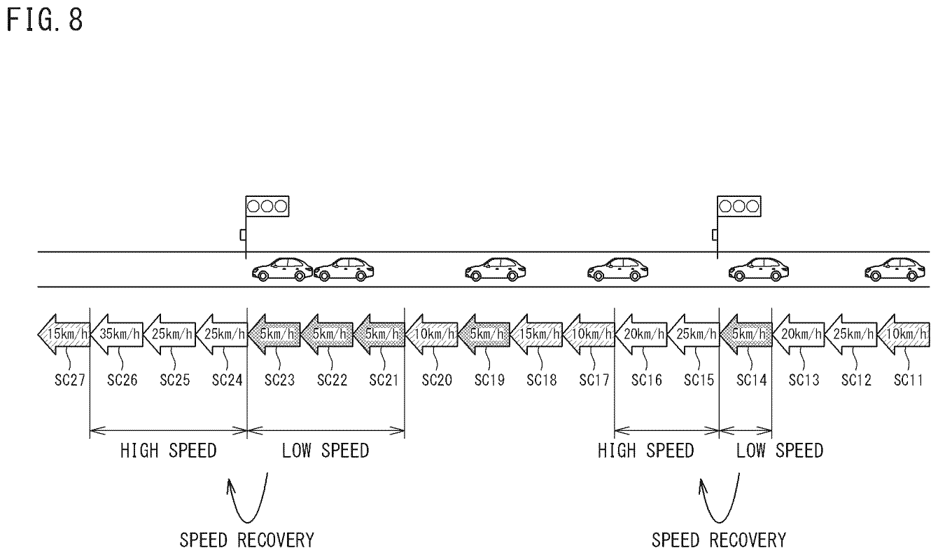

FIG. 8 illustrates an example of bottleneck point classification according to the length in which the same speed range continues. As for the bottleneck point at the downstream end of the section SC14, sections having the speed range of “high speed” on the downstream side of the bottleneck point are the sections SC15 and SC16. That is, in the sections SC15 and SC16, the same speed range, “high speed”, continues. In this case, the classification unit 214 determines the length in which the same speed range continues on the downstream side from the bottleneck point to be, for example, a length of two sections. On the other hand, as for the bottleneck point at the downstream end of the section SC23, sections having the speed range of “high speed” on the downstream side of the bottleneck point are the sections SC24, SC25, SC26. In this case, the classification unit 214 determines the length in which the same speed range continues on the downstream side from this bottleneck point to be, for example a length of three sections. The length may be expressed in meters (m) or the number of sections.

The degree may further include a length in which the same speed range continues on the upstream side from the bottleneck point. That is, the classification unit 214 classifies the bottleneck point by the length in which the same speed range continues on the upstream side from the bottleneck point.

In the example shown in FIG. 8, as for the bottleneck point at the downstream end of the section SC14, only the section SC14 is a section having the speed range of “low speed” on the upstream side of this bottleneck point. In this case, the classification unit 214 determines the length in which the same speed range continues on the upstream side from the bottleneck point to be, for example, a length of one section. On the other hand, as for the bottleneck point at the downstream end of the section SC23, sections having the speed range of “low speed” on the upstream side of the bottleneck point are the sections SC21, SC22, SC23. That is, in the sections SC21, SC22, SC23, the same speed range, “low speed”, continues. In this case, the classification unit 214 determines the length in which the same speed range continues on the upstream side from the bottleneck point to be, for example, a length of three sections.

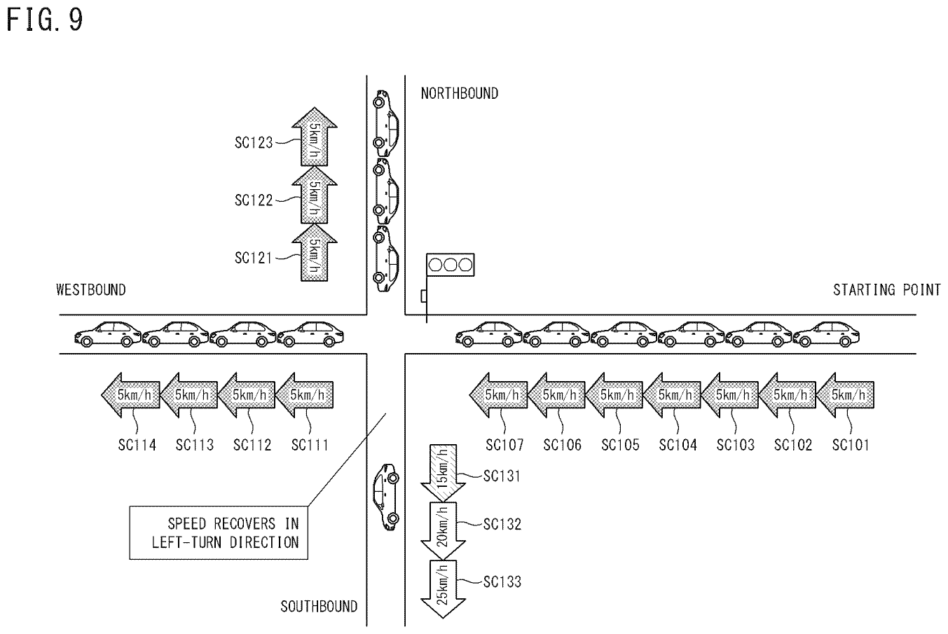

The type may include a vehicle heading direction in which the vehicle speed recovers at the bottleneck point (hereinafter also referred to as “speed recovery direction”). That is, the classification unit 214 classifies the bottleneck points by the speed recovery direction. FIG. 9 illustrates an example of bottleneck point classification according to the speed recovery direction. In FIG. 9, the speed has recovered from the section SC107 to the section SC131 in the left-turn direction (southbound). The speed has not recovered from the section SC107 to the section SC111 in the straight direction (westbound). Likewise, the speed has not recovered from the section SC107 to the section SC121 in the right-turn direction (northbound). Therefore, the intersection at the downstream end of the section SC107 is a bottleneck point, and the speed recovery direction is the left-turn direction (or southbound).

Referring back to FIG. 4, the storage unit 215 causes the analysis result DB 207 to store the traffic information analysis result. Specifically, the storage unit 215 registers, in the analysis result DB 207, the bottleneck point detection result of the detection unit 213 and the bottleneck point classification result of the classification unit 214.

For example, as the bottleneck point detection result, the coordinate position (latitude and longitude) of the bottleneck point is registered in the analysis result DB 207.

For example, as the bottleneck point classification result, information as to whether or not the bottleneck point is an intersection with traffic light is registered in the analysis result DB 207.

As the bottleneck point classification result, information indicating a change in speed range between the upstream-side first section and the downstream-side second section (e.g., “low speed/high speed”, etc.) may be registered in the analysis result DB 207.

As the bottleneck point classification result, information indicating the length in which the same speed range continues on the downstream side from the bottleneck point (e.g., “three sections”, etc.) may be registered in the analysis result DB 207.

As the bottleneck point classification result, information indicating the length in which the same speed range continues on the upstream side from the bottleneck point (e.g., “three sections”, etc.) may be registered in the analysis result DB 207.

As the bottleneck point classification result, information indicating the speed recovery direction (e.g., “right-turn”, etc.) may be registered in the analysis result DB 207.

The generation unit 216 generates display data for superimposing the detected bottleneck points on a map. The provision unit 217 provides the display data generated by the generation unit 216 to a device (e.g., the terminal 6) that requests the analysis result.

In a specific example, an operator (user) of the terminal 6 operates the terminal 6 to request the analysis result. This request includes information indicating an analysis target period specified by the user. This request is transmitted to the traffic information analysis server 2. When the traffic information analysis server 2 has received the request, the generation unit 216 acquires the analysis result in the analysis target period from the analysis result DB 207, and generates display data based on the acquired analysis result. The provision unit 217 transmits the generated display data to the terminal 6 that is the request source. Upon receiving the display data, the terminal 6 displays, on the display device, a map screen in which the bottleneck points are superimposed on the map.

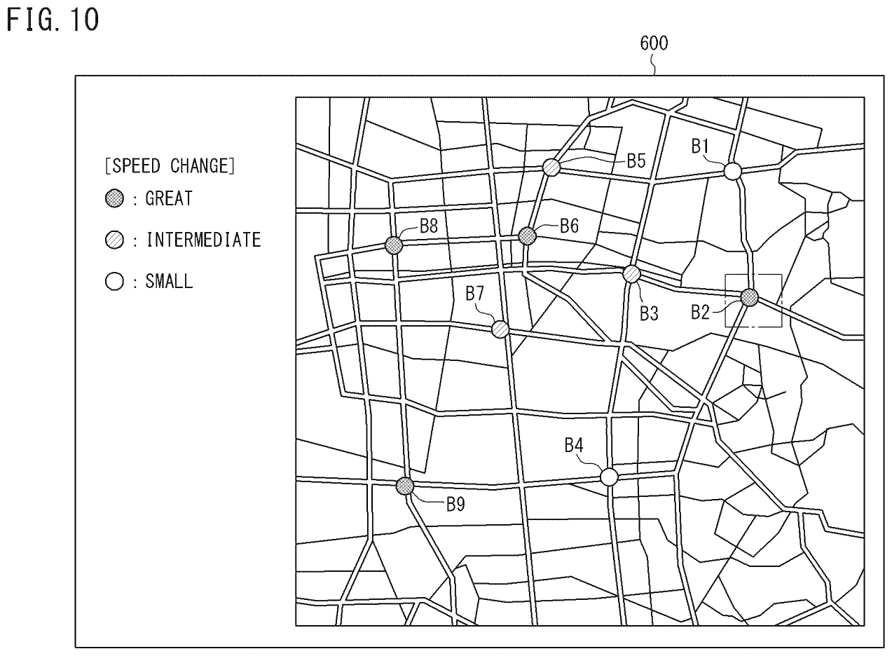

FIG. 10 shows an example of a map screen displayed on a terminal. A map screen 600 includes an image in which bottleneck points are superimposed on a map (wide-area map). In the example shown in FIG. 10, the bottleneck points are represented by round marks. Each bottleneck point is shown in a color according to the degree of change in vehicle speed at the bottleneck point. For example, a bottleneck point where the speed change is great, i.e., the speed range change pattern is “low speed/high speed”, is shown with a red mark. For example, a bottleneck point where the speed change is intermediate, i.e., the speed range change pattern is “low speed/intermediate speed” or “intermediate speed/high speed”, is shown with a yellow mark. For example, a bottleneck point where the speed change is small, i.e., the speed range change pattern is “low speed/low speed”, “intermediate speed/intermediate speed”, or “high speed/high speed”, is shown with a green mark.

In the example shown in FIG. 10, bottleneck points B1, B2, B3, B4, B5, B6, B7, B8, B9 are shown on the map. Of these bottleneck points, the bottleneck points B2, B6, B8, and B9 are bottleneck points where the speed change is great. The bottleneck points B3, B5, and B7 are bottleneck points where the speed change is intermediate. The bottleneck points B1 and B4 are bottleneck points where the speed change is small.

The magnitude of the speed change is one indicator of the degree of a bottleneck point. That is, the greater the speed change, the higher the possibility that the corresponding bottleneck point becomes the starting point of large congestion, and the greater the necessity for improvement. The user can grasp not only the positions of the bottleneck points but also the magnitude of the speed change at each bottleneck point by checking the map screen 600. Therefore, the user can select a location where the traffic state should be improved, taking into account the magnitude of the speed change.

On the map screen 600, the marks of the bottleneck points are selectable by the user. That is, the marks are composed of selectable elements (controls) in a graphical user interface. When the user selects the mark of one bottleneck point, the display transitions to a map screen (hereinafter referred to as “enlarged map screen”) showing the selected bottleneck point and its vicinity being enlarged.

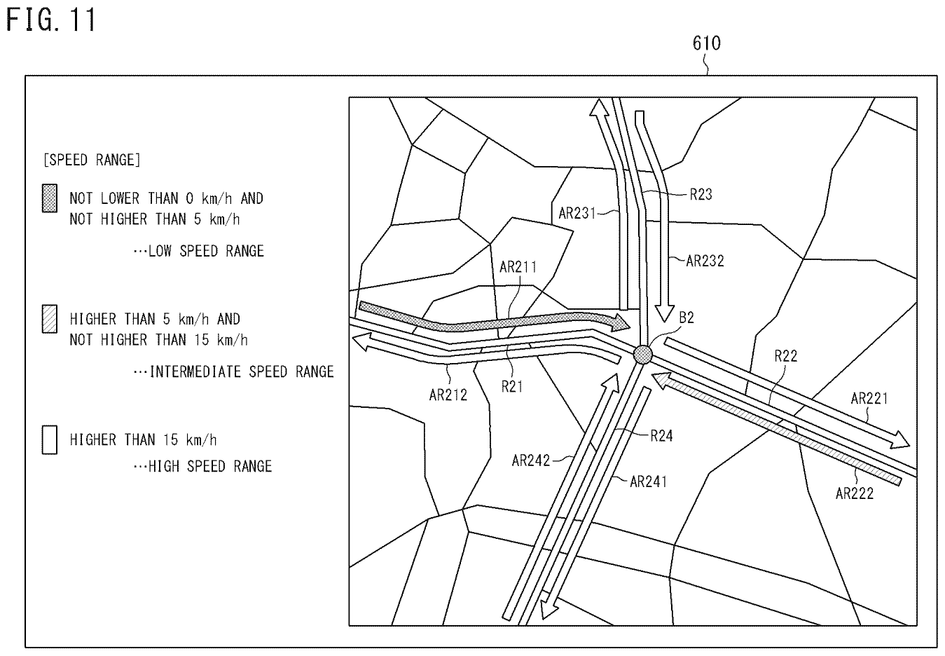

FIG. 11 shows an example of an enlarged map screen displayed on a terminal. FIG. 11 shows an enlarged map screen 610 when a bottleneck point B2 shown in FIG. 10 is selected. The enlarged map screen 610 includes an enlarged map of an area enclosed by a quadrangle formed by a dashed-dotted line shown in FIG. 10.

The enlarged map screen 610 includes an image in which the bottleneck point selected by the user is superimposed on the map. In the example shown in FIG. 11, the bottleneck point is represented by a round mark. The display mode (color) of the mark conforms to FIG. 10.

In the enlarged map screen 610, an area, of the roads included in the map, where the same speed range continues on the upstream side of the bottleneck point is displayed in a specific first mode. Moreover, in the enlarged map screen 610, an area, of the roads included in the map, where the same speed range continues on the downstream side of the bottleneck point is displayed in a specific second mode. In a specific example, the area where the same speed range continues on the upstream side of the bottleneck point (hereinafter also referred to as “upstream-side area”) and the area where the same speed range continues on the downstream side of the bottleneck point (hereinafter also referred to as “downstream-side area”) are displayed in different colors.

A more specific description will be given. In the enlarged map screen 610, the area of the same speed range is represented by an arrow of a color determined for each speed range. For example, the area of “high speed” is green, the area of “intermediate speed” is yellow, and the area of “low speed” is red.

In the example shown in FIG. 11, on a road R21 on the left side of the bottleneck point B2 in the figure, the speed range of the inflow lane at the intersection of the bottleneck point B2 is “low speed”. Therefore, the inflow lane at the bottleneck point B2 on the road R21 is represented by a red arrow AR211. On a road R22 on the right side of the bottleneck point B2 in the figure, the speed range of the outflow lane at the intersection of the bottleneck point B2 is “high speed”. Therefore, the outflow lane at the bottleneck point B2 on the road R22 is represented by a green arrow AR221. On a road R23 on the upper side of the bottleneck point B2 in the figure, the speed range of the outflow lane at the intersection of the bottleneck point B2 is “high speed”. Therefore, the outflow lane at the bottleneck point B2 on the road R23 is represented by a green arrow AR231. On a road R24 on the lower side of the bottleneck point B2 in the figure, the speed range of the outflow lane at the intersection of the bottleneck point B2 is “high speed”. Therefore, the outflow lane at the bottleneck point B2 on the road R24 is represented by a green arrow AR241.

In the above example, the first mode is “red arrow” and the second mode is “green arrow”. However, the first mode and the second mode are not limited to the above example. The first mode and the second mode may be different display modes. For example, the first mode may be “solid-line arrow”, and the second mode may be “broken-line arrow”. Alternatively, the first mode may be “bold arrow”, and the second mode may be “thin arrow”. The first mode and the second mode being different from each other enable the user to distinguish and recognize the upstream-side area and the downstream-side area with respect to the bottleneck point. Moreover, the first mode and the second mode being associated with the speed ranges as described above enable the user to recognize the speed range of the upstream-side area and the speed range of the downstream-side area, respectively.

Furthermore, in the example shown in FIG. 11, on the road R22 on the right side of the bottleneck point B2 in the figure, the speed range of the inflow lane at the intersection of the bottleneck point B2 is “intermediate speed”. Therefore, the inflow lane at the bottleneck point B2 on the road R22 is represented by a yellow arrow AR222. On the road R21 on the left side of the bottleneck point B2 in the figure, the speed range of the outflow lane at the intersection of the bottleneck point B2 is “high speed”. Therefore, the outflow lane at the bottleneck point B2 on the road R21 is represented by a green arrow AR212. On the road R23 on the upper side of the bottleneck point B2 in the figure, the speed range of the inflow lane at the intersection of the bottleneck point B2 is “high speed”. Therefore, the inflow lane at the bottleneck point B2 on the road R23 is represented by a green arrow AR232. On the road R24 on the lower side of the bottleneck point B2 in the figure, the speed range of the inflow lane at the intersection of the bottleneck point B2 is “high speed”. Therefore, the inflow lane at the bottleneck point B2 on the road R24 is represented by a green arrow AR242.

With the enlarged map screen 610 as described above, the user can visually grasp which road is congested starting from the bottleneck point B2, and how long the queue of low-speed vehicles is. Moreover, the user can grasp in which direction, from the bottleneck point B2, the vehicle speed recovers, to what extent the recovery is, and how far the vehicle can travel at the recovered speed.

As described above, the display data transmitted from the provision unit 217 includes data for displaying, in the specific first mode, an area where the same speed range continues on the upstream side of a bottleneck point on a road included in the map, and further includes data for displaying, in the specific second mode, an area where the same speed range continues on the downstream side of a bottleneck point on a road included in the map.

For example, the display data may be divided into first display data for displaying the map screen 600 and second display data for displaying the enlarged map screen 610, and transmitted. In this case, the first display data may include position information of the bottleneck points included in the wide-area map displayed on the map screen 600, and information on the speed change patterns of the respective bottleneck points. The second display data includes position information of the bottleneck point included in the enlarged map displayed on the enlarged map screen 610, and information on the speed change pattern of the bottleneck point. In addition to these pieces of information, the second display data includes information for displaying, in the specific first mode, an area where the same speed range continues on the upstream side of the bottleneck point, and information for displaying, in the specific second mode, an area where the same speed range continues on the downstream side of the bottleneck point.

### [5. Operation of Analysis System]

Next, the operation of the analysis system 1 will be described. The probe vehicles 3 regularly or irregularly transmit probe information including position information and speed information. The probe information transmitted from each probe vehicle 3 is received by the collection server 5. The collection server 5 stores collected probe information in the database.

The processor 201 executing the analysis program 205 enables the traffic information analysis server 2 to execute an analysis process and an analysis result provision process described below.

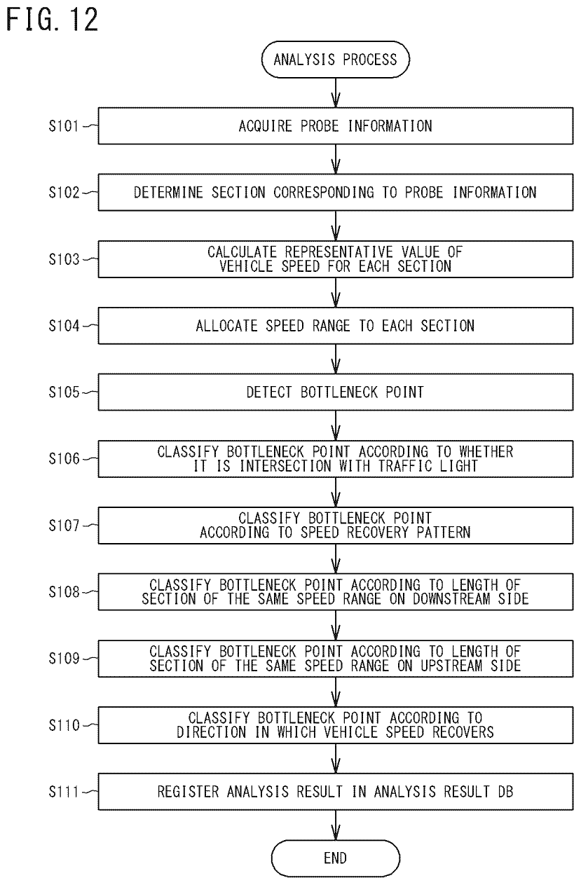

FIG. 12 is a flowchart showing an example of an analysis process by the traffic information analysis server according to the embodiment.

The processor 201 acquires the probe information from the collection server 5 (step S101). Specifically, the processor 201 acquires, for example, probe information specified by the user, or probe information in an analysis target period and an analysis target area that are set in advance. As another example, when detecting and classifying bottleneck points in real time, the processor 201 acquires the latest probe information.

The processor 201 refers to the road map data 261 stored in the map DB 206, and determines sections corresponding to the respective pieces of probe information acquired (step S102). Furthermore, the processor 201 calculates a representative value of vehicle speed for each section by using the vehicle speed information included in the probe information (step S103). The processor 201 allocates a speed range to each section, based on the representative value of the vehicle speed calculated for each section (step S104).

The processor 201 detects a bottleneck point, based on the speeds in adjacent sections (step S105). For example, between the adjacent sections, if the speed range in the downstream-side section is greater than the speed range in the upstream-side section, the processor 201 detects the downstream end of the upstream-side section as a bottleneck point. In another example, between the adjacent sections, if a difference between the speed (representative value) in the upstream-side section and the speed (representative value) in the downstream-side section is equal to or higher than the threshold value, the processor 201 detects the downstream end of the upstream-side section as a bottleneck point.

The processor 201 refers to, for example, the road map data 261, and classifies each detected bottleneck point according to whether or not the bottleneck point is an intersection with traffic light (step S106).

The processor 201 classifies each detected bottleneck point according to the change pattern of the vehicle speed range between the upstream-side first section and the downstream-side second section (step S107).

Furthermore, the processor 201 classifies each detected bottleneck point according to the length in which the same speed range continues on the downstream side from the bottleneck point (step S108). The processor 201 classifies each detected bottleneck point according to the length in which the same speed range continues on the upstream side from the bottleneck point (step S109).

Furthermore, the processor 201 classifies each detected bottleneck point according to the speed recovery direction (step S110).

The processor 201 registers the analysis result of the traffic information in the analysis result DB 207 (step S111). That is, the processor 201 registers each detected bottleneck point in association with the classification result of the bottleneck point, into the analysis result DB 207. For example, in the analysis result DB 207, the analysis result is stored in association with the analysis target period and the analysis target area. This is the end of the analysis process.

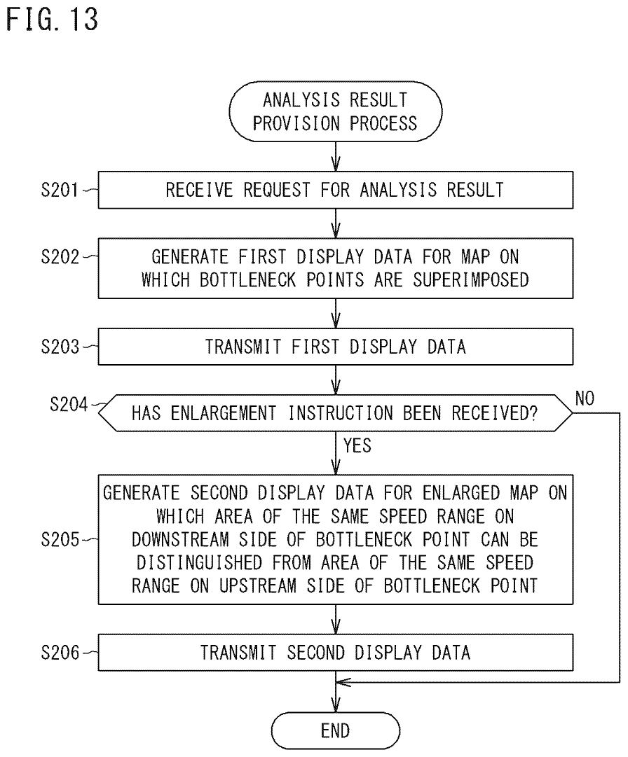

FIG. 13 is a flowchart showing an example of an analysis result provision process by the traffic information analysis server according to the embodiment.

For example, a user of an IT company that provides traffic information services operates the terminal 6 to request the analysis system 1 to provide the analysis result. In this case, for example, the user can specify an analysis target period and an analysis target area. The request includes information on specified analysis target period and analysis target area.

The traffic information analysis server 2 receives the request for the analysis result (step S201). The processor 201 reads out, from the analysis result DB 207, the analysis result corresponding to the analysis target period and the analysis target area that are specified in the request. The processor 201 generates first display data for displaying the map screen 600 by using the read analysis result (step S202). The processor 201 transmits the generated first display data to the terminal 6 that is the source of the request (step S203).

The terminal 6 receives the first display data, and displays the map screen 600 according to the first display data. For example, the user utilizes the map screen 600 as described above when considering measures for traffic congestion in the analysis target period and the analysis target area. By referring to the map screen 600, the user can grasp the position of the bottleneck point and the degree of speed recovery.

If the user desires to check the details of a certain bottleneck point on the map screen 600, the user selects the mark of this bottleneck point. The terminal 6 transmits, to the traffic information analysis server 2, an instruction to enlarge the selected bottleneck point and its vicinity.

The processor 201 determines whether or not an enlargement instruction has been received (step S204). If the traffic information analysis server 2 has not received an enlargement instruction (NO in step S204), the analysis result provision process is ended.

If the traffic information analysis server 2 has received an enlargement instruction (YES in step S204), the processor 201 generates second display data. The second display data is information for displaying an enlarged map on which an area of the same speed range on the downstream side of the bottleneck point and an area of the same speed range on the upstream side of the bottleneck point can be distinguished from each other. The processor 201 transmits the generated second display data to the terminal 6 that is the source of the request (step S206).

The terminal 6 receives the second display data, and displays the enlarged map screen 610 based on the second display data. This is the end of the analysis result provision process.

By referring to the enlarged map screen 610, the user can grasp the lane where traffic congestion is occurring at the bottleneck point, the length of queue of low-speed vehicles, the direction in which the speed recovers, and the distance over which the vehicle can travel with the recovered speed.

By operating the terminal 6, the user can request the traffic information analysis server 2 to provide only an analysis result corresponding to a specific type or degree. For example, if the user specifies “low speed/high speed” as the vehicle speed change pattern, the terminal 6 requests the analysis result in which the vehicle speed change pattern is “low speed/high speed”. The traffic information analysis server 2 reads out, from the analysis result DB 207, the analysis result in which the vehicle speed change pattern is “low speed/high speed”, in addition to the analysis target period and the analysis target area, and generates first display data (and second display data). Thus, only the analysis result corresponding to the condition specified by the user (in this example, analysis result in which the vehicle speed change pattern corresponds to “low speed/high speed”) can be provided to the user.

The analysis system 1 can also provide the analysis result to the driver of the vehicle, rather than the user of the IT company, etc., that provides traffic information services. For example, the terminal 6 may be a navigation device installed in the vehicle. In this case, a real-time bottleneck point detection result and a real-time bottleneck point classification result are provided to the driver. In a specific example, a route searched by the navigation device may be superimposed on the enlarged map screen 610 shown in FIG. 11. Thus, in the searched route or in the vicinity of the searched route, the driver can grasp the position and the type or degree of the bottleneck point, and determine the actual traveling route.

### [6. Supplementary Note]

The embodiment disclosed herein is merely illustrative and not restrictive in all aspects. The scope of the present disclosure is defined by the scope of the claims rather than the embodiment described above, and is intended to include meaning equivalent to the scope of the claims and all modifications within the scope.

### REFERENCE SIGNS LIST

1 analysis system
2 traffic information analysis server
201 processor
202 non-volatile memory
203 volatile memory
204 communication interface (communication I/F)
205 analysis program
206 map database (map DB)
207 analysis result database (analysis result DB)
211 acquisition unit
212 allocation unit
213 detection unit
214 classification unit
215 storage unit
216 generation unit
217 provision unit
261 road map data
3 probe vehicle
5 collection server
6 terminal
8 wireless base station
9 public communication network
40 in-vehicle network
401, 401A in-vehicle control device
402 vehicle speed sensor
403 GNSS receiver
404 external communication device
405 communication line
600 map screen
610 enlarged map screen
L11, L12, L13, L21, L22, L23, L31 link
IS1, IS2 intersection
V1, V2, V3, V4, V5, V6, V7 vehicle
P1, P2, P3, P4, P5, P6, P7 point
SC1, SC2, SC11, SC12, SC13, SC14, SC15, SC16, SC17, SC18, SC19, SC20, SC21, SC22, SC23, SC24, SC25, SC26, SC27, SC101, SC102, SC103, SC104, SC105, SC106, SC107, SC111, SC112, SC113, SC114, SC121, SC122, SC123, SC131, SC132, SC133 section
B1, B2, B3, B4, B5, B6, B7, B8, B9 bottleneck point
R21, R22, R23, R24 road
AR211, AR212, AR221, AR222, AR231, AR232, AR241, AR242 arrow

1. An analysis device comprising:
a detection unit configured to, on a road logically divided into a plurality of sections, detect a bottleneck point that is a starting point of traffic congestion, based on a traveling state of a vehicle on each of the plurality of sections; and
a classification unit configured to classify the bottleneck point by at least one of a type and a degree of the bottleneck point, based on speeds of the vehicle in the sections on an upstream side and a downstream side of the bottleneck point detected by the detection unit.

2. The analysis device according to claim 1, wherein
the detection unit detects the bottleneck point, based on a change in speed of the vehicle in adjacent sections.

3. The analysis device according to claim 1, wherein
the detection unit detects a downstream end of a first section as a bottleneck point, based on a difference between a first speed and a second speed, the first speed being the speed of a first vehicle in a first section, the second speed being the speed of a second vehicle in a second section adjacent to the first section at a downstream side of the first section.

4. The analysis device according to claim 3, wherein
the detection unit detects the downstream end of the first section as a bottleneck point when the difference between the second speed and the first speed is equal to or higher than a threshold value.

5. The analysis device according to claim 1, further comprising an allocation unit configured to allocate, to each section, one of a plurality of predetermined speed ranges, based on the speeds of the vehicle in the plurality of sections, wherein
the detection unit detects the bottleneck point, based on a change in speed range in adjacent sections.

6. The analysis device according to claim 1, wherein
the type includes at least one of: whether or not the bottleneck point is an intersection where a traffic light is installed; and a heading direction, of the vehicle, in which the speed of the vehicle recovers at the bottleneck point.

7. The analysis device according to claim 1, wherein
the degree includes at least one of: a change in speed range of the vehicle between a first section having the bottleneck point at a downstream end thereof and a second section adjacent to the first section at a downstream side of the first section; a length in which the same speed range continues on the downstream side from the bottleneck point; and a length in which the same speed range continues on the upstream side from the bottleneck point.

8. The analysis device according to claim 1, further comprising a generation unit configured to generate display data for superimposing and displaying the detected bottleneck point on a map.

9. The analysis device according to claim 8, wherein
the display data is data for displaying, in a specific first mode, an area where the same speed range continues on the upstream side of the bottleneck point on a road included in the map.

10. The analysis device according to claim 8, wherein
the display data is data for displaying, in a specific second mode, an area where the same speed range continues on the downstream side of the bottleneck point on a road included in the map.

11. An analysis method, comprising:
on a road logically divided into a plurality of sections, detecting a bottleneck point that is a starting point of traffic congestion, based on a traveling state of a vehicle on each of the plurality of sections; and
classifying the bottleneck point by at least one of a type and a degree of the bottleneck point, based on speeds of the vehicle in the sections on an upstream side and a downstream side of the detected bottleneck point.

12. A computer-readable non-transitory storage medium having stored therein an analysis program for causing a computer to execute:
on a road logically divided into a plurality of sections, detecting a bottleneck point that is a starting point of traffic congestion, based on a traveling state of a vehicle on each of the plurality of sections; and
classifying the bottleneck point by at least one of a type and a degree of the bottleneck point, based on speeds of the vehicle in the sections on an upstream side and a downstream side of the detected bottleneck point.
